(19) United States
(12) Patent Application Publication
(10) Pub. No.: US 2016/0248674 A1
(43) Pub. Date: Aug. 25, 2016

(54) DEVICE CAPABILITY ADDRESSABLE NETWORK

(71) Applicant: INTEL CORPORATION, (US)

(72) Inventors: Mrittika Mrittika GANGULI, Bangalore (IN); Deepak S, Bangalore (IN); Mohan J. KUMAR, Aloha, OR (US); Ramamurthy KRITHIVAS, Chandler, AZ (US)

(21) Appl. No.: 14/129,661

(22) PCT Filed: Sep. 27, 2013
(86) PCT No.: PCT/US2013/062152

§ 371 Date: Dec. 27, 2013

(51) Int. Cl. H04L 12/743; H04L 12/715; H04L 12/725; H04L 12/721

(52) U.S. Cl. CPC H04L 45/7453; H04L 45/44; H04L 45/64; H04L 45/302

(57) ABSTRACT

Technologies for using a hash key for communicating via an overlay network include a computing device for receiving a hash key that includes a hash indicative of a requested characteristic of a target computing device and another hash indicative of another requested characteristic of the target computing device. Such technologies may also include parsing the hash key to obtain the hash and the another hash; sending a message that includes the hash to a group of other computing devices; receiving a response message from a computing device of the group indicating that the computing device of the group includes a characteristic matching the requested characteristic; and sending another message that includes the second hash to the computing device of the group in response to receipt of the response message from the computing device of the group.

### BACKGROUND

“Cloud” computing is a term often used to refer to the provisioning of computing resources as a service, usually by a number of computer servers that are networked together at a location remote from the location from which the services are requested. A cloud data center typically refers to the physical arrangement of servers that make up a cloud or a particular portion of a cloud. For example, servers can be physically arranged in the data center into rooms, groups, rows, and racks. A data center may have one or more “zones,” which may include one or more rooms of servers. Each room may have one or more rows of servers, and each row may include one or more racks. Each rack may include one or more individual server nodes. Servers in zones, rooms, racks, and/or rows may be arranged into virtual groups based on physical infrastructure requirements of the data center facility, which may include power, energy, thermal, heat, and/or other requirements.

Notwithstanding its physical location within a data center, a server or portions of its resources may be allocated (e.g., for use by different customers of the data center) according to actual or anticipated use requirements, such as security, quality of service, throughput, processing capacity, and/or other criteria. As an example, one customer's computing workload may be divided among multiple physical servers (which may be located in different rows, racks, groups, or rooms of the data center), or among multiple processes on the same server, using virtualization. Thus, in the context of virtualization, servers can be grouped logically to satisfy workload requirements.

A data center management system, which may include computer software, is typically used to manage the server resources in a data center. For example, some data center management systems attempt to reconcile customers' workload requirements with facilities management criteria and/or other requirements, and allocate the data center's server resources accordingly. In some cases, scheduling may be complicated by physical configurations that contain heterogeneous groups of servers, e.g., zones, rooms, groups, rows, or racks in which individual servers have different hardware configurations. Such complications can be a common occurrence, as many data centers replace or upgrade servers only as needed (e.g., rather than upgrading an entire group at once), for cost reasons or otherwise. Additionally, communicating with heterogeneous groups of servers may be complicated in data centers in which servers are dynamically provisioned and/or taken offline based on workload requirements. For example, in many data center environments, servers are typically addressed and managed using an Internet Protocol (IP) address and/or a Media Access Control (MAC) address. In such environments, servers that have not yet been provisioned with an IP and/or MAC address may not be discoverable and/or manageable by a data center management system.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for using a hash key to communicate via an overlay network;

FIG. 2 is a simplified block diagram of at least one embodiment of a computing device for using the hash key to communicate via the overlay network of the system of FIG. 1;

FIG. 3 is a simplified block diagram of at least one embodiment of an environment of the computing device of FIG. 2;

FIG. 4 is a simplified flow diagram of at least one embodiment of a method that may be executed by the computing device of FIG. 2 for generating and updating a local hash key;

FIG. 5 is an illustrative embodiment of a hash key that may be used by the computing device of FIG. 2 to route messages via an overlay network;

FIG. 6 is a simplified flow diagram of at least one embodiment of a method that may be executed by the computing device of FIG. 2 for using a hash key to route messages via an overlay network; and

FIG. 7 is a simplified flow diagram of at least one embodiment of a method that may be executed by the computing device of FIG. 2 for receiving a message via an overlay network using a hash key.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

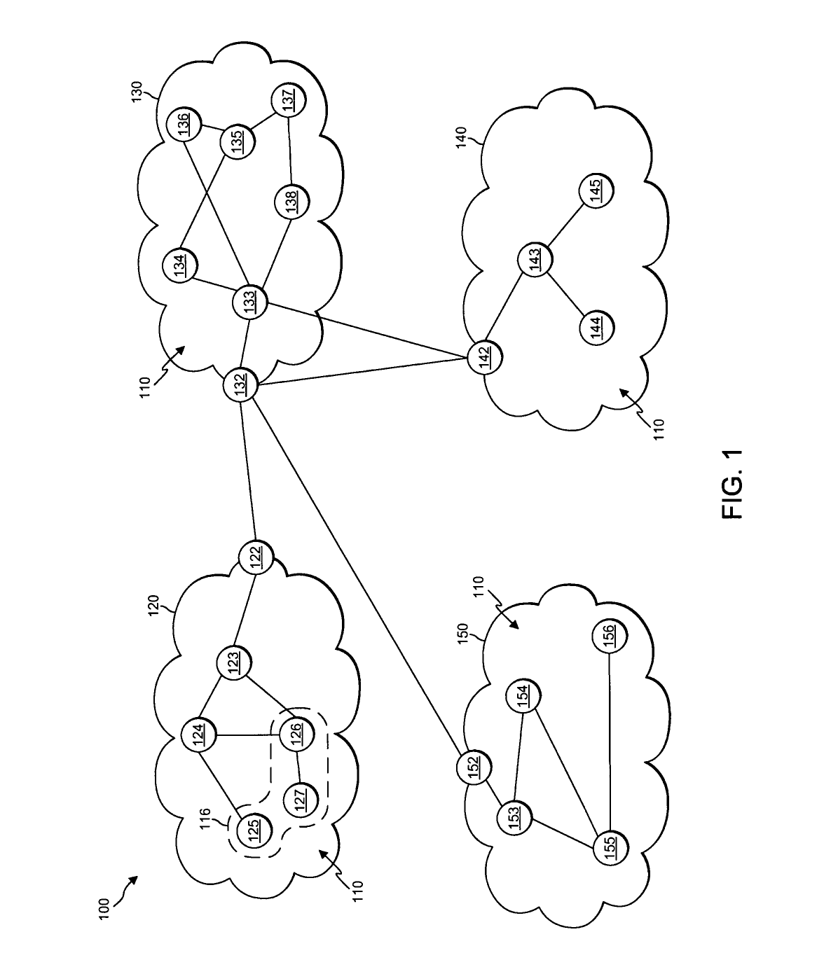

Referring now to FIG. 1, in an illustrative embodiment, a system 100 for using a hash key to communicate via an overlay network includes one or more nodes 110, each of which may be embodied as one or more computing devices and may be referred to in following description as node(s) 110 and/or computing device(s) 110. In some embodiments, multiple nodes 110 (e.g., the computing devices 122-127, 132-138, 142-145, 152-156) may be arranged into one or more zones 120, 130, 140, 150 based on physical infrastructure requirements of a data center facility (e.g., location, rack, power, energy, thermal, heat, and/or other requirements), workload requirements (e.g., security, quality of service, throughput, processing capacity, and/or other criteria), and/or device characteristics or capabilities (e.g., processor type, memory capacity, memory usage, power state, power capacity, power consumption, storage capacity, storage usage, availability, performance metrics, etc.). Additionally, any number of the nodes 110 (e.g., the nodes 125-127) may be arranged into any number of groups (e.g., the group 116) within a particular zone (e.g., the zone 120) based on the same or different requirements. In any case, each of the nodes 110 may be configured to utilize a structured overlay network to communicate with one or more other nodes 110 via one or more underlying networks (not shown) such as, for example, the Internet, a local area network (LAN), a wide area network (WAN), a personal area network (PAN), or any other type of network. In the illustrative embodiment, each node 110 is configured to utilize a distributed hash table to locate and communicate with one or more other nodes 110.

To facilitate locating and/or communicating with other nodes 110 of the structured overlay network, each node 110 may generate a personal hash key representative of its characteristics and/or capabilities (e.g., processor type, memory capacity, memory usage, power state, power capacity, power consumption, storage capacity, storage usage, availability, security policy, security level, performance metrics, etc.). Each node 110 may distribute its personal hash key and/or a hash table including its personal hash key to one or more other nodes 110 within the same group 116, within the same zone 120, 130, 140, 150, within other groups or zones 120, 130, 140, 150, and/or across one or more underlying networks. In some embodiments, each node 110 may continuously (or according to a reference interval) monitor for changes to its characteristics and/or capabilities. In such embodiments, the nodes 110 may be further configured to update their personal hash keys in response to determining that one or more of their characteristics and/or capabilities have changed. In that way, each node 110 may be addressable within the structured overlay network based on its individual characteristics and/or capabilities.

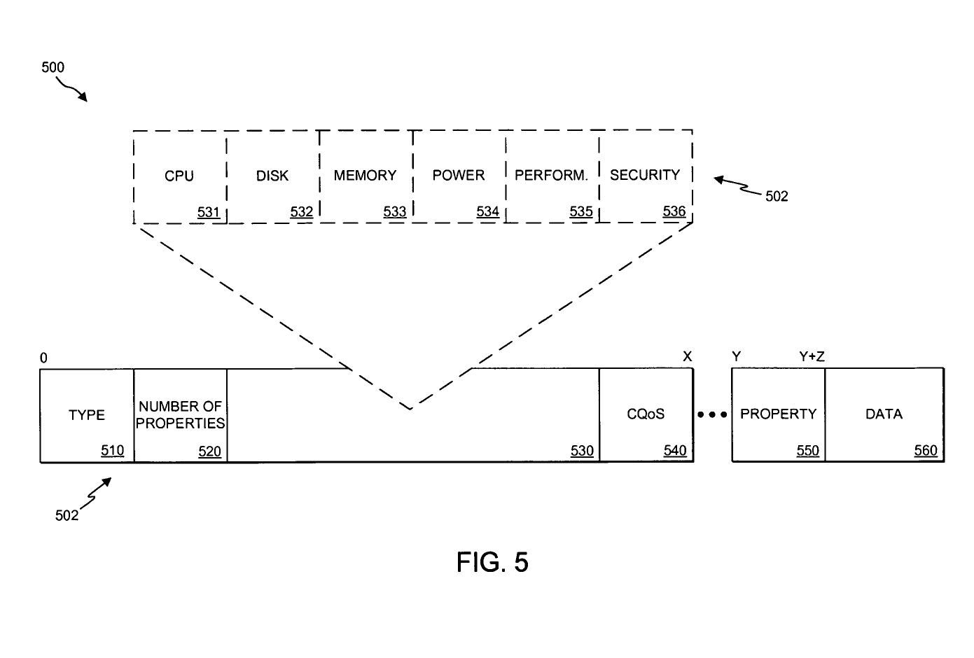

In some embodiments, a node 110 (e.g., the computing device 122) may receive a message from another node 110 (e.g., the computing device 132) and route that message to one or more other nodes 110 (e.g., the computing devices 123-127) based on a hash key (e.g., the hash key 500 shown in FIG. 5) included within the message. As discussed in more detail below, the hash key 500 is indicative of one or more characteristics and/or capabilities of an intended or target node 110 and/or a group of the nodes 110. That is, the hash key 500 included within the message may be used to facilitate routing the message to one or more nodes 110 having corresponding (e.g., matching) characteristics and/or capabilities.

Additionally, in some embodiments, a node 110 (e.g., the computing device 132) may receive a message from another node 110 (e.g., the computing device 122) that includes a hash key 500 as well as information indicative of an action to be performed by the receiving node 110 (e.g., the computing device 132). In such embodiments, the receiving node 110 (e.g., the computing device 132) may be configured to perform the action in response to determining that it includes characteristics and/or capabilities that correspond to the one or more characteristics and/or capabilities indicated by the hash key 500. That is, in response to determining that it is the proper destination (e.g., one of the intended target nodes) for the message, the receiving node 110 (e.g., the computing device 132) may perform the requested action.

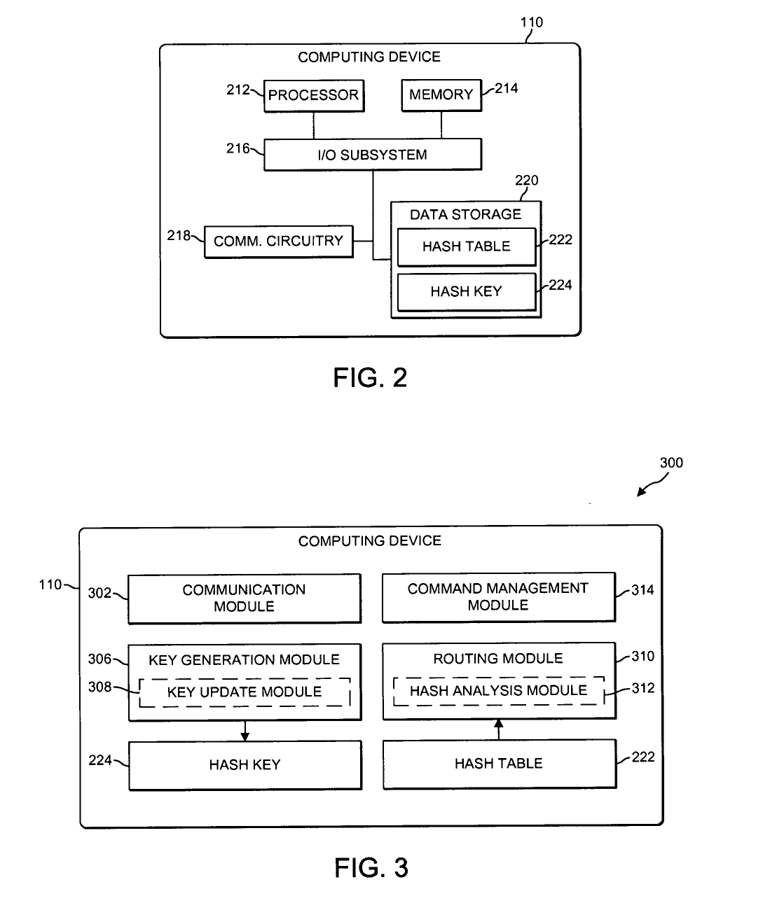

As discussed above, each of the computing devices 110 may be embodied as one or more computing devices of any type capable of performing the functions described herein including, but not limited to, a server computer, a desktop computer, a laptop computer, a set-top box, a smart display device, a mobile phone, a smart phone, a tablet computing consumption device, a personal digital assistant, a consumer electronic device, a smart television, and/or other type of computing device. As shown in FIG. 2, an illustrative computing device 110 (i.e., a node 110) of the system 100 may include a processor 212, a memory 214, an input/output (I/O) subsystem 216, communication circuitry 218, and a data storage 220. Of course, the computing device 110 may include other or additional components, such as those commonly found in a server and/or computer (e.g., various input/output devices), in other embodiments. Additionally, in some embodiments, one or more of the illustrative components may be incorporated in, or otherwise from a portion of, another component. For example, the memory 214, or portions thereof, may be incorporated in the processor 212 in some embodiments.

The processor 212 may be embodied as any type of processor capable of performing the functions described herein. For example, the processor 212 may be embodied as a single or multi-core processor(s), digital signal processor, microcontroller, or other processor or processing/controlling circuit. Similarly, the memory 214 may be embodied as any type of volatile or non-volatile memory or data storage capable of performing the functions described herein. In operation, the memory 214 may store various data and software used during operation of the computing device 110 such as operating systems, applications, programs, libraries, and drivers. The memory 214 is communicatively coupled to the processor 212 via the I/O subsystem 216, which may be embodied as circuitry and/or components to facilitate input/output operations with the processor 212, the memory 214, and other components of the computing device 110. For example, the I/O subsystem 216 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 216 may form a portion of a system-on-a-chip (SoC) and be incorporated, along with the processor 212, the memory 214, and other components of the computing device 110, on a single integrated circuit chip.

The communication circuitry 218 of the computing device 110 may be embodied as any type of communication circuit, device, or collection thereof, capable of enabling communications between the computing device 110 and one or more other computing devices 110. The communication circuitry 218 may be configured to use any one or more communication technologies (e.g., wireless or wired communications) and associated protocols (e.g., Ethernet, Wi-Fi®, WiMAX, etc.) to effect such communication. As discussed in more detail below, the computing devices 110 of the system 100 use a structured overlay network to communicate with each other. The structured overlay network may be established using one or more underlying networks (not shown). The one or more underlying networks may be embodied as any number of various wired and/or wireless communication networks. For example, one or more of the underlying networks may be embodied as or otherwise include a local area network (LAN), a wide area network (WAN), a cellular network, or a publicly-accessible, global network such as the Internet. Additionally, one or more of the underlying networks may include any number of additional devices to facilitate structured overlay communications between the computing devices 110.

The data storage 220 may be embodied as any type of device or devices configured for short-term or long-term storage of data such as, for example, memory devices and circuits, memory cards, hard disk drives, solid-state drives, or other data storage devices. In the illustrative embodiment, the data storage 220 may include a hash key 224 and a hash table 222. As discussed in more detail below, the hash key 224 may include information indicative of the characteristics and/or capabilities (e.g., processor type, memory capacity, memory usage, power state, power capacity, power consumption, storage capacity, storage usage, availability, security policy, security level, performance metrics, etc.) of the computing device 110. In that way, the hash key 224 may be embodied as a “personal” or “local” hash key 224 corresponding to the particular computing device 110. In some embodiments, each characteristic and/or capability of the computing device 110 may be embodied as a separate hash. In such embodiments, the hash key 224 may be formed from a concatenation and/or aggregation of multiple hashes.

The hash table 222 may include any number of hashes or hash keys corresponding to any number of other computing devices 110 (e.g., the other nodes 110) with which the particular computing device 110 may communicate. The hashes and/or hash keys included within the hash table 222 may be embodied as the personal hash keys received from other computing devices 110. Thus, in the illustrative embodiment, the hash table 222 maps particular characteristics and/or capabilities to one or more computing devices 110 (e.g., the nodes 110). Additionally, in some embodiments, the hash table 222 may also include a value for each hash and/or hash key contained therein. For example, in embodiments wherein the computing devices 110 (i.e., the nodes 110) are configured to communicate with each other over the structured overlay network via an underlying network (e.g., LAN, WAN, PAN, etc.), the hash table 222 may also include a value for each hash and/or hash key indicative of an underlying network address (e.g., Internet Protocol address, Media Access Protocol address, etc.) assigned to each corresponding computing device 110.

Referring now to FIG. 3, in use, each of the computing devices 110 (i.e., the nodes 110) establishes an environment 300 during operation. The illustrative environment 300 includes a communication module 302, a key generation module 306, and a routing module 310, and a command management module 314, each of which may be embodied as software, firmware, hardware, or a combination thereof. It should be appreciated that each of the computing devices 110 may include other components, sub-components, modules, and devices commonly found in a computing device, which are not illustrated in FIG. 3 for clarity of the description. Additionally, it should be understood that although each of the computing devices 110 may establish the illustrative environment 300 during operation, the following discussion of that illustrative environment 300 is described with specific reference to the computing device 122 for clarity of the description.

The communication module 302 of the computing device 122 facilitates communications between components or sub-components of the computing device 122 and other computing device(s) 110 of the system 100. For example, in some embodiments, the communication module 302 receives messages from and/or transmits messages to the other computing devices 110 through the structured overlay network and/or the underlying network. As discussed, in some embodiments, the messages sent to and/or received from the other computing devices 110 may include a local hash key 224 indicative of the characteristics and/or capabilities of the computing device 122, a local hash key 224 indicative of the characteristics and/or capabilities of another computing device 110, a hash key 500 (see FIG. 5) indicative of the characteristics and/or capabilities of a target/destination computing device 110, and/or information indicative of one or more actions to be performed by the target/destination computing device 110.

The key generation module 306 may be configured to generate a hash key 224 for the computing device 122. The generated hash key 224 may be indicative of one or more characteristics and/or capabilities (e.g., processor type, memory capacity, memory usage, power state, power capacity, power consumption, storage capacity, storage usage, availability, security policy, security level, performance metrics, etc.) of the computing device 122 (i.e., different computing devices 110 of the system 100 may generate different hash keys 224 based on their own particular characteristics/capabilities). In some embodiments, the key generation module 306 may generate a separate hash for each characteristic and/or capability of the computing device 122. In such embodiments, the hash key 224 may be embodied as a concatenation and/or an aggregation of the separate hash for each characteristic and/or capability. For example, the hash key 224 may include a hash indicative of the type of processor of the computing device 122 and another hash indicative of the amount of memory that the computing device 122 is currently using. It should be appreciated that the hash key 224 may contain one, two, or more hashes, each of which may be indicative of a different characteristic and/or capability of the computing device 122.

Additionally, the key generation module 306 may be configured to update the hash key 224 corresponding to the computing device 122. For example, in some embodiments, one or more characteristics and/or capabilities of the computing device 122 may change in response to the occurrence of one or more events (e.g., workload increase/decrease, hardware/software upgrade, network congestion, device availability/unavailability, etc.). In such embodiments, the key generation module 306 may include a key update module 308 to monitor for and respond to changes of any of the characteristics and/or capabilities of the computing device 122. To do so, the key update module 308 may be configured to continually, periodically, and/or responsively monitor the characteristics and/or capabilities of the computing device 122 to determine whether any have changed. For example, the key update module 308 may be configured to determine whether any of the characteristics and/or capabilities of the computing device 122 have changed according to a reference interval (e.g., once per hour, once per day, once per week, etc.). Regardless of how often the key update module 308 determines whether any of the characteristics and/or capabilities of the computing device 122 have changed, the key update module 308 may update the hash key 224 based at least in part on, or otherwise as a function of, the determined changes. In embodiments wherein the hash key 224 includes multiple hashes concatenated and/or aggregated together, the key update module 308 may be configured to update only those hashes that correspond to a characteristic and/or capability that has changed. If the key update module 308 updates the hash key 224, the updated hash key 224 and/or a hash table including the updated hash key 224 may be provided to the other computing devices 110.

The routing module 310 is configured to receive target messages from another computing devicc(s) 110 of the system 100. For example, the computing device 132 (or other computing device 110 of the system 100) may transmit a target message to the computing device 122. In some embodiments, the messages received from the computing device 132 (or other computing device 110) may include a hash key 500 indicative of the characteristics and/or capabilities of a target/destination computing device 110 for the target messages. In such embodiments, the routing module 310 may use the characteristics and/or capabilities indicated by the hash key 500 to route the one or more messages to a target/destination computing device 110 (or a group 116 of target/destination computing devices 110) having the same or substantially similar characteristics and/or capabilities. In some embodiments, the messages received from the computing device 132 (or other computing device 110) may be received as part of a broadcast or a multicast transmission sent by the computing device 132 (or other computing device 110). Additionally, in some embodiments, the hash key 500 and other data may be embedded within one or more header fields of each message. For example, in embodiments wherein the computing device 132 broadcasts or multicasts the messages to the computing device 122 and other computing devices 110 of the system 100, at least a portion of the hash key 500 and other data may be embedded within one or more reserved header fields (e.g., multicast reserved fields, etc.) of each message.

In embodiments wherein the hash key 500 is embodied as a concatenation and/or aggregation of one or more hashes, the routing module 310 may be configured to parse the hash key 500 to obtain the individual hashes contained therein. To do so, the routing module 310 may parse the hash key 500 according to a specific number of storage units (e.g., nibbles, bits, bytes, etc.) identified within the hash key 500, a specific number of characteristics and/or capabilities identified within the hash key 500, and/or any other suitable process for breaking down (e.g., parsing, separating, dividing, splitting, etc.) the hash key 500 into component hashes.

The routing module 310 of the computing device 122 may be configured also to determine which computing devices 110 to route any received messages based at least in part on, or otherwise as a function of, the hash key 500 and the local hash table 222 of the computing device 122. To do so, the routing module 310 may include a hash analysis module 312. The hash analysis module 312 may be configured to utilize the local hash table 222 of the computing device 122 to determine whether any of the one or more computing devices 110 contained within the local hash table 222 has characteristics and/or capabilities that match the characteristics and/or capabilities indicated by the hash key 500 (or the individual hashes contained therein).

In embodiments wherein the computing device 122 is the target/destination computing device 110 for a message including a hash key 500, the command management module 314 is configured to determine whether the message also contains information indicative of an action to be performed by the computing device 122. For example, in some embodiments, the received message may also include a command or an instruction requesting the computing device 122 to implement or reconfigure a Quality of Service (QoS) policy (e.g., set a storage or memory cache size, change a power state, prioritize data transmissions, prioritize data processing, etc.). Of course it should be appreciated that the requested action may also include any other type of action (e.g., respond to an information request, enable/disable components or services, etc.) to be performed by the computing device 122. In some embodiments, the action information may be embodied as a hash representative of a command or instruction, which may be embedded in one or more header fields of the message. Additionally or alternatively, the action information may be embodied as an actual command or instruction (e.g., pseudocode, an instruction identifier, a recognizable instruction, etc.) embedded within a payload portion of the message. Regardless, in embodiments wherein the message includes action information, the command management module 314 may parse the message to obtain the corresponding instruction or command information. Upon obtaining the information indicative of the requested action, the command management module 314 may be configured to perform, or otherwise cause the performance of, the requested action.

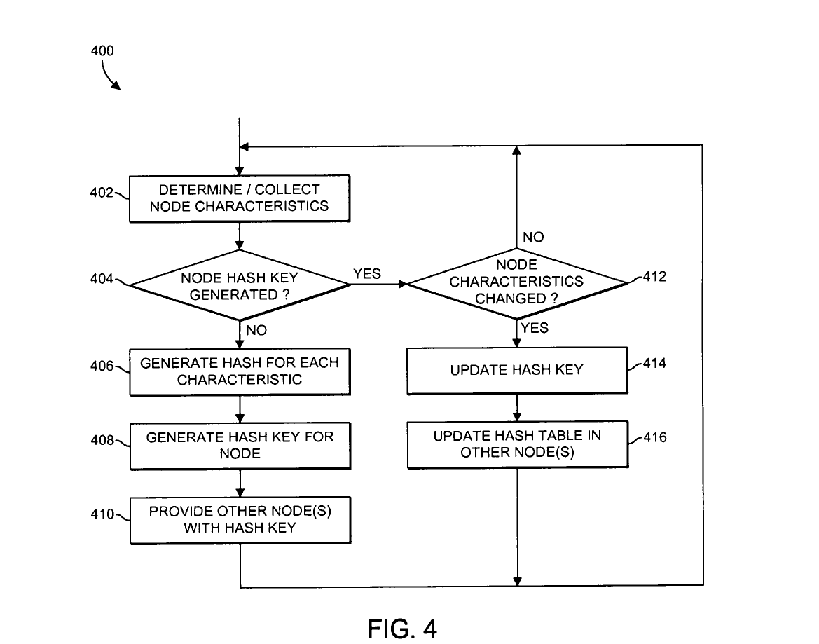

Referring now to FIG. 4, in use, each of the computing devices 110 of the system 100 may execute a method 400 for generating and updating a hash key 224 (e.g., a “local” or “personal” hash key 224). The method 400 begins with block 402 in which the computing device 110 determines and/or collects its characteristics and/or capabilities (e.g., processor type, memory capacity, memory usage, power state, power capacity, power consumption, storage capacity, storage usage, availability, security policy, security level, performance metrics, etc.). In some embodiments, the computing device 110 executes a software agent to determine its current characteristics and/or capabilities. Additionally or alternatively, the computing device 110 may receive data indicative of its current characteristics and/or capabilities directly from the components to which the characteristics and/or capabilities relate.

In block 404, the computing device 110 determines whether a hash key 224 has been previously generated. To do so, in some embodiments, the computing device 110 determines whether a hash key 224 is stored in the data storage 220. If, in block 404, the computing device 110 determines that a hash key 224 has not been generated, the method 400 advances to block 406. If, however, the computing device 110 determines in block 404 that the hash key 224 has already been generated, the method 400 advances to block 412.

In block 406, the computing device 110 generates a hash for each characteristic and/or capability of the computing device 110. In some embodiments, the hash generated for each characteristic and/or capability of the computing device 110 is embodied as data indicative of that particular characteristic and/or capability. For example, each hash may be a string of characters (e.g., letters, numbers, symbols, or any combination thereof) representative of a corresponding characteristic and/or capability. In such embodiments, the computing device 110 may derive each hash from a textual label or description corresponding to each characteristic and/or capability. It should be appreciated that any other process of generating hashes and/or data indicative of a characteristic and/or capability of the computing device 110 may also be used in other embodiments.

In block 408, subsequent to generating a hash for each of its characteristics and/or capabilities, the computing device 110 generates its own hash key 224. To do so, in some embodiments, the computing device 110 concatenates, combines, and/or aggregates each of the hashes into a single hash key 224, which may be later parsed by another computing device 110 (e.g., the computing device 132) for message routing and/or performance of a requested action.

In block 410, after generating the hash key 224, the computing device 110 provides its hash key 224 to one or more other computing devices 110 of the system 100. In doing so, the computing device's 110 hash key 224 may be included in the local hash table 222 of one or more of the other computing devices 110. Upon providing its hash key 224 to the one or more other computing devices 110, the method 400 returns to block 402 in which the computing device 110 continues determining and/or collecting its own characteristics and/or capabilities.

In block 412, in response to determining that the hash key 224 was previously generated, the computing device 110 determines whether any of its own characteristics and/or capabilities has changed. To do so, in some embodiments, the computing device 110 compares its current characteristics and/or capabilities to the characteristics and/or capabilities used to generate the already existing hash key 224. If, in block 412, the computing device 110 determines that none of its own characteristics and/or capabilities have changed, the method 400 returns to block 402 in which the computing device 110 continues determining and/or collecting its own characteristics and/or capabilities. If, however, the computing device 110 determines that one or more of its characteristics and/or capabilities has changed, the method advances to block 414.

In block 414, the computing device 110 updates its hash key 224 based at least in part on the one or more characteristics and/or capabilities determined to have changed. To do so, in some embodiments, the computing device 110 generates new hashes for each changed characteristic and/or capability. Thereafter, the computing device 110 updates its hash key 224 to include the updated (e.g., newly generated) hashes. In some embodiments, the computing device 110 may generate a new hash key 224 rather than updating the individual hashes of the previously generated hash key 224.

In block 416, after updating its hash key 224, the computing device 110 provides its updated hash key 224 to one or more other computing devices 110 of the system 100. In doing so, the computing device's 110 hash key 224 may be updated in the local hash table 222 of the other computing device(s) 110. Upon providing its updated hash key 224 to the other computing device(s) 110, the method 400 returns to block 402 in which the computing device 110 continues determining and/or collecting its own characteristics and/or capabilities.

As discussed above, in some embodiments, a computing device 110 of the system 100 may receive a target message from another computing device 110 via a structured overlay network. The target message may include a hash key 500, which may be used to facilitate routing the message to a target/destination computing device 110. In some embodiments, the hash key 500 or a portion thereof may be embedded within one or more header fields of the received message. As such, the hash key 500 may be in a format compatible to be embedded within the one or more header fields of the message.

An illustrative hash key 500 is shown in FIG. 5. The illustrative hash key 500 may include a plurality of header fields 502 that precede the actual data 560 (e.g., the payload 560) of the message. For example, in the illustrative embodiment shown in FIG. 5, the hash key 500 includes a type field 510 to indicate the existence of the hash key 500 within one or more of the header fields 502 of the message. The hash key 500 also includes an offset field 520 (e.g., the “number of properties” field 520) to indicate the number of characteristics and/or capabilities that are included within a corresponding number of additional header fields 530. Each of the additional header fields 530 may contain a separate characteristic and/or capability of the target/destination computing device 110. For example, the illustrative additional header fields 530 includes a processor type field 531, a disk (e.g., storage) usage field 532, a memory usage field 533, a power consumption field 534, a device performance field 535, and/or a security level field 536. Of course, it should be appreciated that the additional header fields 530 may include any other type of field indicative of a capability and/or characteristic (e.g., memory capacity, power state, power capacity, storage capacity, availability, security policy, etc.) of the target/destination computing device 110.

In some embodiments, the hash key 500 may also include information indicative of one or more commands requested to be performed by the target/destination computing device 110 as discussed above. For example, as illustratively shown in FIG. 5, the hash key 500 may include an action field 540 (e.g., the CQoS field 540) to indicate that an action is to be performed by the target/destination computing device 110. In such embodiments, the hash key 500 may further include a command field 550 (e.g., the property field 550) indicative of the specific instruction, command, configuration, and/or action to be performed by the target/destination computing device 110. Of course, it should be appreciated that in some embodiments, the action to be performed and/or the specific instructions may instead be included within the payload 560 (e.g., the data portion 560) of the message. Additionally, it should be appreciated that in some embodiments, a format substantially similar to the one shown in FIG. 5 may also be used by each of the computing devices 110 to generate and/or update their individual hash keys 224.

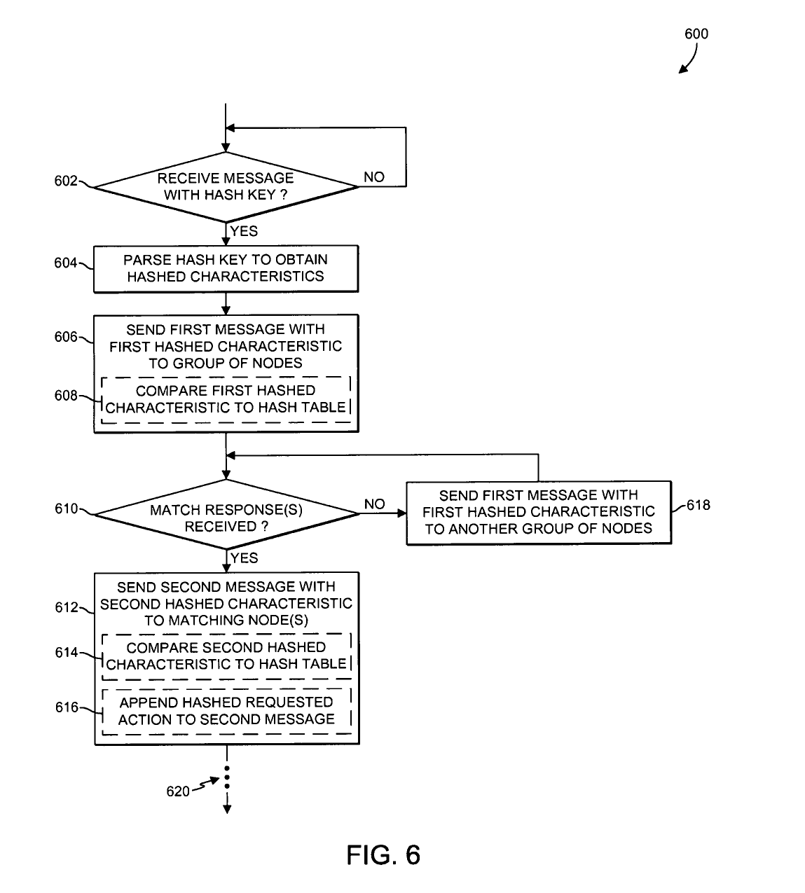

Referring now to FIG. 6, if a computing device 110 of the system 100 receives a message including a hash key 500, the computing device 110 may execute a method 600 for routing the message via the overlay network using the hash key 500. The method 600 begins with block 602 in which the computing device 110 determines whether a message including the hash key 500 has been received from a “source” computing device 110 of the system 100. As discussed, the hash key 500 includes one or more hashes, each being indicative of a different requested characteristic and/or capability for a target/destination computing device 110 or a group 116 of target/destination computing devices 110. That is, the individual hashes within the hash key 500 indicate what characteristics and/or capabilities a particular computing device 110 or a group 116 of computing devices 110 must have to be the intended recipient of the message. If, in block 602, the computing device 110 receives a message including a hash key 500, the method 600 advances to block 604. If, however, a message including the hash key 500 is not received, the method 600 returns to block 602 in which the computing device 110 continues to determine whether a message including the hash key 500 has been received.

In block 604, the computing device 110 parses the hash key 500 to obtain the individual or component hashes corresponding to the characteristics and/or capabilities of the target/destination computing device 110 or the group 116 of target/destination computing devices 110. For example, in embodiments wherein the message includes a hash key 500 containing multiple (e.g., two or more) individual hashes, the computing device 110 parses the hash key 500 to obtain each individual hash.

In block 606, the computing device 110 sends a first message including one of the individual hashes to another computing device 110 or group of other computing devices 110 of the system 100. As such, the first message may be different from the original message received from the “source” computing device 110 in that the first message may not include the entire hash key 500 (e.g., all of the individual hashes). The computing device 110 may utilize any suitable methodology to determine which other computing devices 110, or groups thereof, to which to transmit the first message. For example, in some embodiments, the computing device 110 may transmit the first message as a broadcast message to a large number of other computing devices 110. Additionally or alternatively, the computing device 110 may transmit the first message as a multicast message to a group or subgroup of other computing devices 110. For example and referring back to FIG. 1, should computing device 122 receive a message including a hash key 500, the computing device 122 may parse the hash key 500 to identify the individual hashes and transmit a message including one of the individual hashes to a group 116 of other computing devices (i.e., computing devices 125, 126, 127). The computing device 110 may identify the other computing device(s) 110 or groups of other computing devices 110 using the hash table 222 or other methodology. For example and referring back to FIG. 6, the computing device 110 may compare an individual hash to its local hash table 222 in block 608. In such embodiments, the computing device 110 may define a group 116 of one or more of the computing devices 110 to which the first message should be sent based at least in part on, or otherwise as a function of, determining that the individual hash matches one or more hashes in the hash table 222.

In block 610, the computing device 110 determines whether a response to the first message was received from one or more of the computing devices 110 of the group 116. In some embodiments, receiving a response to the first message from one of the computing devices 110 of the group 116 is indicative of that computing device 110 having a characteristic and/or capability that matches the requested characteristic and/or capability indicated by the first hash. If, in block 610, the computing device 110 determines that one or more response messages to the first message have been received from one or more of the computing devices 110 of the group 116, the method 600 advances to block 612.

In block 612, the computing device 110 sends a second message including the next individual hash (e.g., the second hash) obtained from the hash key 500 to one or more of the computing devices 110 of the group 116 from which a response to the first message was received. In some embodiments, in block 614, the computing device 110 may also compare the next individual hash (e.g., the second hash) to the computing device's 110 local hash table 222. In such embodiments, the computing device 110 may define another group of computing devices 110 within the group 116 (e.g., a subgroup) to which the second message should be sent based at least in part on, or otherwise as a function of, determining that the next individual hash (e.g., the second hash) matches one or more hashes in the hash table 222. It should be appreciated that in some embodiments, the subgroup of computing devices 110 defined by the computing device 110 may include one or more of the computing devices 110 of the group 116 from which a response to the first message was received.

In some embodiments, in block 616, the original message received from the “source” computing device 110 may also include information indicative of an action to be performed by the target/destination computing device 110 or the group 116 of target/destination computing devices 110. For example, the originally received message may also include a command and/or an instruction requesting the target/destination computing device 110 or the group 116 of target/destination computing devices 110 to implement or reconfigure a local Quality of Service (QoS) policy (e.g., set a storage or memory cache size, change a power state, prioritize data transmissions, prioritize data processing, etc.). In some embodiments, the command and/or instruction may be embodied as an actual command and/or instruction, or it may be embodied as a hash representative of a command and/or an instruction. Regardless, in embodiments wherein the original message includes information indicative of an action to be performed by the target/destination computing device 110 or the group 116 of target/destination computing devices 110, the computing device 110 may obtain and append the information indicative of the action to be performed (e.g., an actual and/or hashed command or instruction) to the second message.

If, in block 610, the computing device 110 determines that one or more response messages to the first message have not been received, the method 600 advances to block 618 in which the computing device 110 sends the first message including the first hash to another group (not shown) of computing devices 110. Subsequently, the method 600 loops back to block 610 in which the computing device 110 determines whether a response to the first message was received from one or more of the computing devices 110 of the other group. If so, the method 600 advances to block 612 in which the computing device 110 sends the second message including the second hash to the one or more computing devices 110 of the another group from which a response to the first message was received.

It should be appreciated that, in some embodiments, the first and/or second messages may be sent to one or more of the computing devices 110 as a broadcast or a multicast message. Additionally or alternatively, the first and/or second messages may be sent to one or more of the computing devices 110 as a unicast message. Regardless, the hash key 500 or the individual component hashes may be embedded within one or more header and/or payload fields of the first and/or second messages. For example, in some embodiments the hash key 500 or the individual component hashes may be embedded within one or more reserved header fields (e.g., multicast reserved fields, etc.) of the first and/or second messages.

Additionally, it should be appreciated that although the computing device 110 sends two messages (e.g., the first and second messages including the first and second hashes) to one or more computing devices 110 of the group 116 in the illustrative embodiment, the computing device 110 may send more than two messages (e.g., as illustratively shown by the ellipsis 620) to the one or more computing devices 110 of the group 116 in other embodiments. In such embodiments, the computing device 110 may also send a message for each hashed characteristic and/or capability obtained from the received hash key 500.

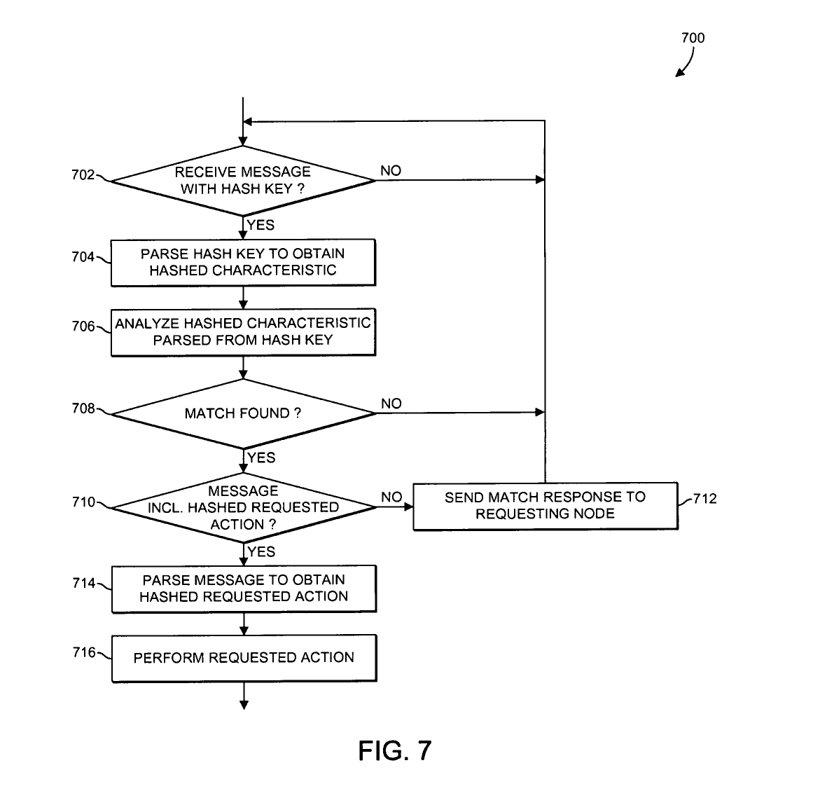

Referring now to FIG. 7, if a computing device 110 of the system 100 receives a message including a hash key via the overlay network, the computing device 110 may execute a method 700 determining whether the computing device 110 is the target/destination of the received message. The method 700 begins with block 702 in which the computing device 110 determines whether a message including the hash key 500 has been received from another computing device 110 of the system 100. As discussed, the hash key 500 includes one or more hashes, each being indicative of a different requested characteristic and/or capability of a target/destination computing device 110 or a group 116 of target/destination computing devices 110. If, in block 702, the computing device 110 receives a message including the hash key 500, the method 700 advances to block 704. If, however, a message including the hash key 500 is not received, the method 700 returns to block 702 in which the computing device 110 continues to determine whether a message including the hash key 500 has been received.

In block 704, the computing device 110 parses the hash key 500 to obtain a hash representative of a requested characteristic and/or capability of the target/destination computing device 110 (or the group 116 of target/destination computing devices 110). The method 700 then advances to block 706.

In block 706, the computing device 110 analyzes the hash representative of the requested characteristic and/or capability of the target/destination computing device 110. Subsequently in block 708, the computing device 110 may determine whether the requested characteristic and/or capability indicated by the hash matches one or more of its own characteristics and/or capabilities. To do so, in some embodiments, the computing device 110 may compare the hash with its own current characteristics and/or capabilities. Additionally or alternatively, the computing device 110 may compare the hash representative of the requested characteristic and/or capability to one or more hashes of its own characteristics and/or capabilities. If, in block 708, the computing device 110 determines that the characteristic and/or capability indicated by the hash matches one of its own characteristics and/or capabilities, the method 700 advances to block 710. In such embodiments, the computing device 110 may determine that it is the target/destination computing device 110. If, however, the computing device 110 determines instead that the characteristic and/or capability indicated by the hash does not match one of its own characteristics and/or capabilities, the method 700 returns to block 702.

In block 710, the computing device 110 determines whether the message received from the other computing device 110 of the system 100 includes information indicative of a requested action to be performed (e.g., an actual and/or hashed command or instruction). If, in block 710, the computing device 110 determines that the received message does not include information indicative of a requested action to be performed, the method 700 advances to block 712 in which the computing device 110 sends a response message to the other computing device 110 indicating that it contains one or more characteristics and/or capabilities matching the requested characteristic and/or capability indicated by the hash. If, however, the computing device 110 determines instead that the received message includes information indicative of a requested action to be performed, the method 700 advances to block 714.

In block 714, the computing device 110 parses the received message to obtain the corresponding instruction or command information. Subsequently, in block 716, the computing device 110 performs the requested action.

### EXAMPLES

Illustrative examples of the technologies disclosed herein are provided below. An embodiment of the technologies may include any one or more, and any combination of, the examples described below.

Example 1 includes a computing device to communicate via an overlay network, the computing device includes a routing module to: (i) receive a hash key including a first hash indicative of a first requested characteristic of a target computing device, and a second hash indicative of a second requested characteristic of the target computing device; (ii) parse the hash key to obtain the first hash and the second hash; (iii) send a first message including the first hash to a first group of other computing devices, (iv) receive a response message from a first computing device of the first group, the response message to indicate that the first computing device includes a characteristic matching the first requested characteristic; and (v) send a second message including the second hash to the first computing device in response to receipt of the response message from the first computing device.

Example 2 includes the subject matter of Example 1, and wherein the routing module is further to send the first message to a second group of other computing devices in response to not receiving a response message from any of the other computing devices of the first group.

Example 3 includes the subject matter of any of Examples 1 and 2, and wherein the routing module is further to: (i) compare the first hash to a hash table, the hash table mapping hashes of characteristics to computing devices; and (ii) define the first group based on the comparison of the first hash to the hash table.

Example 4 includes the subject matter of any of Examples 1-3, and wherein the routing module is further to generate the second message based on the second hash and a third hash, the third hash indicative of a requested action to be performed by the first computing device; and wherein to send the second message includes to send a second message including the second and third hashes to the first computing device.

Example 5 includes the subject matter of any of Examples 1-4, and wherein the requested action to be performed by the first computing device includes a quality of service policy to be configured by the first computing device.

Example 6 includes the subject matter of any of Examples 1-5, and wherein at least one of the first requested characteristic or the second requested characteristic includes at least one of a requested processor type, storage utilization, storage capacity, memory utilization, memory capacity, power utilization, power capacity, security level, performance level, or availability of the target computing device.

Example 7 includes the subject matter of any of Examples 1-6 and wherein to receive the hash key includes to receive a message that includes header information, the header information includes a plurality of fields in which at least a portion of the hash key is embedded.

Example 8 includes a method for using a hash key to communicate via an overlay network, the method includes receiving, by a computing device, a hash key including: (i) a first hash indicative of a first requested characteristic of a target computing device, and (ii) a second hash indicative of a second requested characteristic of the target computing device; parsing, by the computing device, the hash key to obtain the first hash and the second hash; sending, by the computing device, a first message including the first hash to a first group of other computing devices; receiving, by the computing device, a response message from a first computing device of the first group, the response message to indicate that the first computing device includes a characteristic matching the first requested characteristic; and sending, by the computing device, a second message including the second hash to the first computing device in response to receipt of the response message from the first computing device.

Example 9 includes the subject matter of Example 8, and further includes sending, by the computing device, the first message to a second group of other computing devices in response to not receiving a response message from any of the other computing devices of the first group.

Example 10 includes the subject matter of any of Examples 8 and 9, and further includes comparing, by the computing device, the first hash to a hash table, the hash table mapping hashes of characteristics to computing devices; and defining, by the computing device, the first group based on the comparison of the first hash to the hash table.

Example 11 includes the subject matter of any of Examples 8-10, and further includes generating, by the computing device, the second message based on the second hash and a third hash, the third hash indicative of a requested action to be performed by the first computing device; and wherein sending the second message includes sending a second message including the second and third hashes to the first computing device.

Example 12 includes the subject matter of any of Examples 8-11, and wherein the requested action to be performed by the first computing device includes a quality of service policy to be configured by the first computing device.

Example 13 includes the subject matter of any of Examples 8-12, and wherein at least one of the first requested characteristic or the second requested characteristic includes at least one of a requested processor type, storage utilization, storage capacity, memory utilization, memory capacity, power utilization, power capacity, security level, performance level, or availability of the target computing device.

Example 14 includes the subject matter of any of Examples 8-13, and wherein receiving the hash key includes receiving a message that includes header information, the header information includes a plurality of fields in which at least a portion of the hash key is embedded.

Example 15 includes one or more machine readable media including a plurality of instructions stored thereon that in response to being executed result in a computing device performing the method of any of Examples 8-14.

Example 16 includes a computing device to communicate via an overlay network, the computing device includes means for performing the method of any of Examples 8-14.

Example 17 includes a computing device to receive a hash key via an overlay network, the computing device includes a routing module to: (i) receive a message that includes a hash key from another computing device, the hash key includes a first hash indicative of an identified characteristic requested by the another computing device; (ii) parse the hash key to obtain the first hash; (iii) determine whether the computing device includes a characteristic matching the identified characteristic indicated by the first hash; and (iv) send a response message to the another computing device in response to a determination that the computing device includes a characteristic that matches the identified characteristic indicated by the first hash.

Example 18 includes the subject matter of Example 17, and further including a command management module to: (i) determine whether the message received from the another computing device includes a requested action to be performed by the computing device; (ii) parse the message to obtain the requested action; and (iii) perform the requested action.

Example 19 includes the subject matter of any of Examples 17 and 18, and wherein to determine whether the message received from the another computing device includes the requested action includes to determine whether the message received from the another computing device includes a second hash, the second hash indicative of the requested action to be performed by the computing device.

Example 20 includes the subject matter of any of Examples 17-19, and wherein the requested action to be performed by the computing device includes an action to configure a quality of service policy on the computing device.

Example 21 includes the subject matter of any of Examples 17-20, and wherein the identified characteristic requested by the another computing device includes at least one of a requested processor type, storage utilization, storage capacity, memory utilization, memory capacity, power utilization, power capacity, security level, performance level, or availability of the computing device.

Example 22 includes the subject matter of any of Examples 17-21, and wherein the message received from the another computing device includes header information, the header information includes a plurality of fields in which at least a portion of the hash key is embedded.

Example 23 includes a method for receiving a hash key via an overlay network, the method includes receiving, by a computing device, a message including a hash key from another computing device, the hash key includes a first hash indicative of an identified characteristic requested by the another computing device; parsing, by the computing device, the hash key to obtain the first hash; determining, by the computing device, whether the computing device includes a characteristic matching the identified characteristic indicated by the first hash; and sending, by the computing device, a response message to the another computing device in response to determining that the computing device includes a characteristic matching the identified characteristic indicated by the first hash.

Example 24 includes the subject matter of Example 23, and further includes determining, by the computing device, whether the message received from the another computing device includes a requested action to be performed by the computing device; parsing, by the computing device, the message to obtain the requested action; and performing, by the computing device, the requested action.

Example 25 includes the subject matter of any of Examples 23 and 24, and wherein determining whether the message received from the another computing device includes the requested action includes determining whether the message received from the another computing device includes a second hash, the second hash indicative of the requested action to be performed by the computing device.

Example 26 includes the subject matter of any of Examples 23-25, and wherein the requested action to be performed by the computing device includes an action for configuring a quality of service policy on the computing device.

Example 27 includes the subject matter of any of Examples 23-26, and wherein the identified characteristic requested by the another computing device includes at least one of a requested processor type, storage utilization, storage capacity, memory utilization, memory capacity, power utilization, power capacity, security level, performance level, or availability of the computing device.

Example 28 includes the subject matter of any of Examples 23-27, and wherein the message received from the another computing device includes header information, the header information includes a plurality of fields in which at least a portion of the hash key is embedded.

Example 29 includes one or more machine readable media having a plurality of instructions stored thereon that in response to being executed result in a computing device performing the method of any of Examples 23-28.

Example 30 includes a computing device to receive a hash key via an overlay network, the computing device includes means for performing the method of any of Examples 23-28.

Example 31 includes a computing device to generate a hash key for communication via an overlay network, the computing device includes a key generation module to: (i) determine characteristics of the computing device; (ii) determine whether a hash key for the computing device has been generated; (iii) generate a hash for each of the determined characteristics of the computing device in response to a determination that a hash key has not been generated for the computing device; (iv) generate a hash key based on the hash generated for each of the determined characteristics of the computing device; and (v) send the hash key to another computing device.

Example 32 includes the subject matter of Example 31, and wherein the key generation module is further to: (i) determine whether one or more of the determined characteristics of the computing device has changed; (ii) update the hash key based on a determination that one or more of the determined characteristics of the computing device has changed; (iii) and send the updated hash key to the another computing device.

Example 33 includes the subject matter of any of Examples 31 and 32, and wherein the determined characteristics of the computing device includes at least one a processor type, storage utilization, storage capacity, memory utilization, memory capacity, power utilization, power capacity, security level, performance level, or availability of the computing device.

Example 34 includes a method for generating a hash key for communication via an overlay network, the method includes determining, by a computing device, characteristics of the computing device; determining, by the computing device, whether a hash key has been generated for the computing device; generating, by the computing device, a hash for each of the determined characteristics of the computing device in response to determining that a hash key has not been generated for the computing device; generating, by the computing device, a hash key based on the hash generated for each of the determined characteristics of the computing device; and sending, by the computing device, the hash key to another computing device.

Example 35 includes the subject matter of Example 34, and further includes determining, by the computing device, whether one or more of the determined characteristics of the computing device has changed; updating, by the computing device, the hash key based on determining that one or more of the determined characteristics of the computing device has changed; and sending, by the computing device, the updated hash key to the another computing device.

Example 36 includes the subject matter of any of Examples 34 and 35, and wherein the determined characteristics of the computing device includes at least one a processor type, storage utilization, storage capacity, memory utilization, memory capacity, power utilization, power capacity, security level, performance level, or availability of the computing device.

Example 37 includes one or more machine readable media having a plurality of instructions stored thereon that in response to being executed result in a computing device performing the method of any of Examples 34-36.

Example 38 includes a computing device to generate a hash key for communication via an overlay network, the computing device includes means for performing the method of any of Examples 34-36.

1-25. (canceled)

26. A computing device to communicate via an overlay network, the computing device comprising:
a routing module to: (i) receive a hash key comprising a first hash indicative of a first requested characteristic of a target computing device, and a second hash indicative of a second requested characteristic of the target computing device; (ii) parse the hash key to obtain the first hash and the second hash; (iii) send a first message comprising the first hash to a first group of other computing devices, (iv) receive a response message from a first computing device of the first group, the response message to indicate that the first computing device includes a characteristic matching the first requested characteristic; and (v) send a second message comprising the second hash to the first computing device in response to receipt of the response message from the first computing device.

27. The computing device of claim 26, wherein the routing module is further to send the first message to a second group of other computing devices in response to not receiving a response message from any of the other computing devices of the first group.

28. The computing device of claim 26, wherein the routing module is further to: (i) compare the first hash to a hash table, the hash table mapping hashes of characteristics to computing devices; and (ii) define the first group based on the comparison of the first hash to the hash table.

29. The computing device of claim 26, wherein the routing module is further to generate the second message based on the second hash and a third hash, the third hash indicative of a requested action to be performed by the first computing device; and
wherein to send the second message comprises to send a second message comprising the second and third hashes to the first computing device.

30. The computing device of claim 29, wherein the requested action to be performed by the first computing device comprises a quality of service policy to be configured by the first computing device.

31. The computing device of claim 26, wherein at least one of the first requested characteristic or the second requested characteristic comprises at least one of a requested processor type, storage utilization, storage capacity, memory utilization, memory capacity, power utilization, power capacity, security level, performance level, or availability of the target computing device.

32. The computing device of claim 26, wherein to receive the hash key comprises to receive a message that includes header information, the header information comprises a plurality of fields in which at least a portion of the hash key is embedded.

33. One or more machine readable media comprising a plurality of instructions stored thereon that in response to being executed by a computing device, cause the computing device to:
receive a hash key comprising a first hash indicative of a first requested characteristic of a target computing device, and a second hash indicative of a second requested characteristic of the target computing device;
parse the hash key to obtain the first hash and the second hash;
send a first message comprising the first hash to a first group of other computing devices,
receive a response message from a first computing device of the first group, the response message to indicate that the first computing device includes a characteristic matching the first requested characteristic; and
send a second message comprising the second hash to the first computing device in response to receipt of the response message from the first computing device.

34. The one or more machine readable media of claim 33, wherein the plurality of instructions further cause the computing device to send the first message to a second group of other computing devices in response to not receiving a response message from any of the other computing devices of the first group.

35. The one or more machine readable media of claim 33, wherein the plurality of instructions further cause the computing device to:
compare the first hash to a hash table, the hash table mapping hashes of characteristics to computing devices; and
define the first group based on the comparison of the first hash to the hash table.

36. The one or more machine readable media of claim 33, wherein the plurality of instructions further cause the computing device to generate the second message based on the second hash and a third hash, the third hash indicative of a requested action to be performed by the first computing device; and
wherein to send the second message comprises to send a second message comprising the second and third hashes to the first computing device.

37. The one or more machine readable media of claim 36, wherein the requested action to be performed by the first computing device comprises a quality of service policy to be configured by the first computing device.

38. The one or more machine readable media of claim 33, wherein at least one of the first requested characteristic or the second requested characteristic comprises at least one of a requested processor type, storage utilization, storage capacity, memory utilization, memory capacity, power utilization, power capacity, security level, performance level, or availability of the target computing device.

39. The one or more machine readable media of claim 33, wherein to receive the hash key comprises to receive a message that includes header information, the header information comprises a plurality of fields in which at least a portion of the hash key is embedded.

40. A computing device to receive a hash key via an overlay network, the computing device comprising:
a routing module to: (i) receive a message that includes a hash key from another computing device, the hash key comprises a first hash indicative of an identified characteristic requested by the another computing device; (ii) parse the hash key to obtain the first hash; (iii) determine whether the computing device includes a characteristic matching the identified characteristic indicated by the first hash; and (iv) send a response message to the another computing device in response to a determination that the computing device includes a characteristic that matches the identified characteristic indicated by the first hash.

41. The computing device of claim 40, further comprising a command management module to: (i) determine whether the message received from the another computing device includes a requested action to be performed by the computing device; (ii) parse the message to obtain the requested action; and (iii) perform the requested action.

42. The computing device of claim 41, wherein to determine whether the message received from the another computing device includes the requested action comprises to determine whether the message received from the another computing device includes a second hash, the second hash indicative of the requested action to be performed by the computing device.

43. The computing device of claim 40, wherein the requested action to be performed by the computing device comprises an action to configure a quality of service policy on the computing device.

44. The computing device of claim 40, wherein the identified characteristic requested by the another computing device comprises at least one of a requested processor type, storage utilization, storage capacity, memory utilization, memory capacity, power utilization, power capacity, security level, performance level, or availability of the computing device.

45. The computing device of claim 40, wherein the message received from the another computing device includes header information, the header information comprises a plurality of fields in which at least a portion of the hash key is embedded.

46. One or more machine readable media comprising a plurality of instructions stored thereon that in response to being executed by a computing device, cause the computing device to:
receive a message that includes a hash key from another computing device, the hash key comprises a first hash indicative of an identified characteristic requested by the another computing device;
parse the hash key to obtain the first hash;
determine whether the computing device includes a characteristic matching the identified characteristic indicated by the first hash; and
send a response message to the another computing device in response to a determination that the computing device includes a characteristic that matches the identified characteristic indicated by the first hash.

47. The one or more machine readable media of claim 46, wherein the plurality of instructions further cause the computing device to:
determine whether the message received from the another computing device includes a requested action to be performed by the computing device;
parse the message to obtain the requested action; and
perform the requested action.

48. The one or more machine readable media of claim 47, wherein to determine whether the message received from the another computing device includes the requested action comprises to determine whether the message received from the another computing device includes a second hash, the second hash indicative of the requested action to be performed by the computing device.

49. The one or more machine readable media of claim 46, wherein the requested action to be performed by the computing device comprises an action to configure a quality of service policy on the computing device.

50. The one or more machine readable media of claim 46, wherein the message received from the another computing device includes header information, the header information comprises a plurality of fields in which at least a portion of the hash key is embedded.
